(19) United States
(12) Patent Application Publication
(10) Pub. No.: US 2025/0232569 A1
(43) Pub. Date: Jul. 17, 2025

(54) METHOD AND SYSTEM FOR DEEP LEARNING BASED PERCEPTION

(71) Applicant: Fox Robotics, Austin, TX (US)

(72) Inventors: Peter Anderson-Sprecher, Austin, TX (US); Arun Joseph, Austin, TX (US); Aaron Dennis, Austin, TX (US); Chinmay Garg, Austin, TX (US)

(73) Assignee: Fox Robotics, Austin, TX (US)

(21) Appl. No.: 18/410,774

(22) Filed: Jan. 11, 2024

(51) Int. Cl. G06V 10/82; G06V 20/58

(52) U.S. Cl. CPC G06V 10/82; G06V 20/58

(57) ABSTRACT

A method and a system for deep learning-based perception are disclosed. The method includes obtaining input data using a plurality of cameras and a plurality of sensors, the input data including a plurality of images and a plurality of sensor data and training, using a machine learning algorithm, a trunk-head machine learning model. Further, the method includes generating an intermediate representation data using the trunk-head machine learning model and determining a plurality of information recognized in the intermediate representation data using the trunk-head machine learning model and based on the obtained input data. A configuration of a forklift is adjusted based on the determined plurality of information.

### BACKGROUND

Forklifts are vehicles commonly used in industrial settings to lift and transport heavy packages. The forklifts are important for efficient storage operations as they provide easy stocking and organizing the packages in an open space or on shelves. Further, the forklifts enable optimized use of the space and improve overall productivity in warehouse management.

Based on the presence or absence of the required human control, the forklifts may be manual and/or automated. The automated forklifts use sensors, cameras, navigation systems, and processing units to navigate around a warehouse and to transport packages autonomously. The autonomous behavior of the forklifts may be based on the deep learning-based perception technology that uses deep neural networks to enable the forklift to perceive and interpret the surroundings.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method for deep learning-based perception including obtaining input data using a plurality of cameras and a plurality of sensors, the input data including a plurality of images and a plurality of sensor data and training, using a machine learning algorithm, a trunk-head machine learning model. Further, the method includes generating intermediate representation data using the trunk-head machine learning model and determining a plurality of information recognized in the intermediate representation data using the trunk-head machine learning model and based on the obtained input data. A configuration of a forklift is adjusted based on the determined plurality of information.

In general, in one aspect, embodiments disclosed herein relate to a non-transitory computer readable medium storing a set of instructions executable by a computer processor for deep learning-based perception. The set of instructions includes the functionality for obtaining input data using a plurality of cameras and a plurality of sensors, the input data including a plurality of images and a plurality of sensor data and training, using a machine learning algorithm, a trunk-head machine learning model. Further, an intermediate representation data is generated using the trunk-head machine learning model and a plurality of information recognized in the intermediate representation data is determined using the trunk-head machine learning model and based on the obtained input data. A configuration of a forklift is adjusted based on the determined plurality of information.

In general, in one aspect, embodiments disclosed herein relate to a system including a plurality of cameras, a plurality of sensors, and a computer processor, wherein the computer processor is coupled to the plurality of cameras and the plurality of sensors, the computer processor comprising functionality for obtaining input data using a plurality of cameras and a plurality of sensors, the input data including a plurality of images and a plurality of sensor data and training, using a machine learning algorithm, a trunk-head machine learning model. Further, an intermediate representation data is generated using the trunk-head machine learning model and a plurality of information recognized in the intermediate representation data is determined using the trunk-head machine learning model and based on the obtained input data. A configuration of a forklift is adjusted based on the determined plurality of information.

Other aspects and advantages will be apparent from the following description and the appended claims.

### BRIEF DESCRIPTION OF DRAWINGS

Specific embodiments of the invention will now be described in detail with reference to the accompanying figures. Like elements in the various figures are denoted by like reference numerals for consistency. Like elements may not be labeled in all figures for the sake of simplicity.

FIGS. 1A-IC show an automated forklift system, in accordance with one or more embodiments of the invention.

FIGS. 2A-2C show an architecture for two sources of control of the forklift, in accordance with one or more embodiments of the invention.

FIG. 3A shows an architecture for deep learning-based perception, in accordance with one or more embodiments of the invention.

FIG. 3B shows a flowchart describing deep learning-based perception, in accordance with one or more embodiments of the invention.

FIG. 4 shows a neural network in accordance with one or more embodiments.

FIG. 5 shows a flowchart in accordance with one or more embodiments.

FIG. 6 shows a machine learning model's recognition of a pallet and pallet's face-side pockets, in accordance with one or more embodiments of the invention.

FIG. 7 shows a machine learning model's recognition of forks, in accordance with one or more embodiments of the invention.

FIG. 8 shows a machine learning model's recognition of load restraints, in accordance with one or more embodiments of the invention.

FIG. 9 shows a computing system in accordance with one or more embodiments of the invention.

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

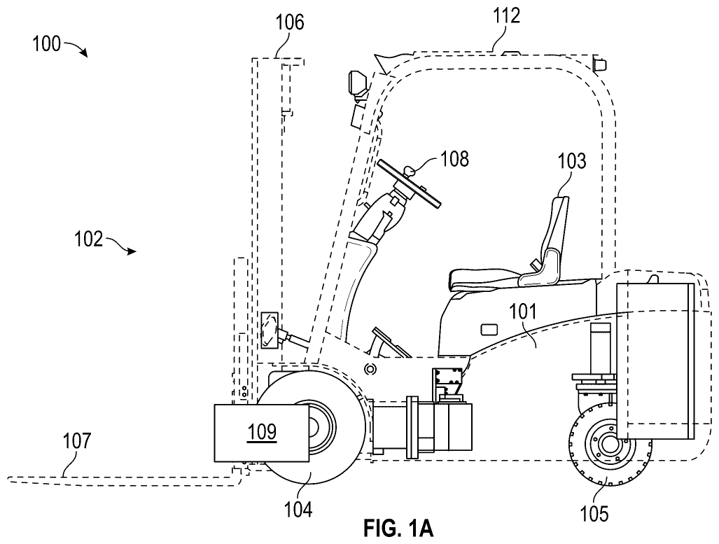

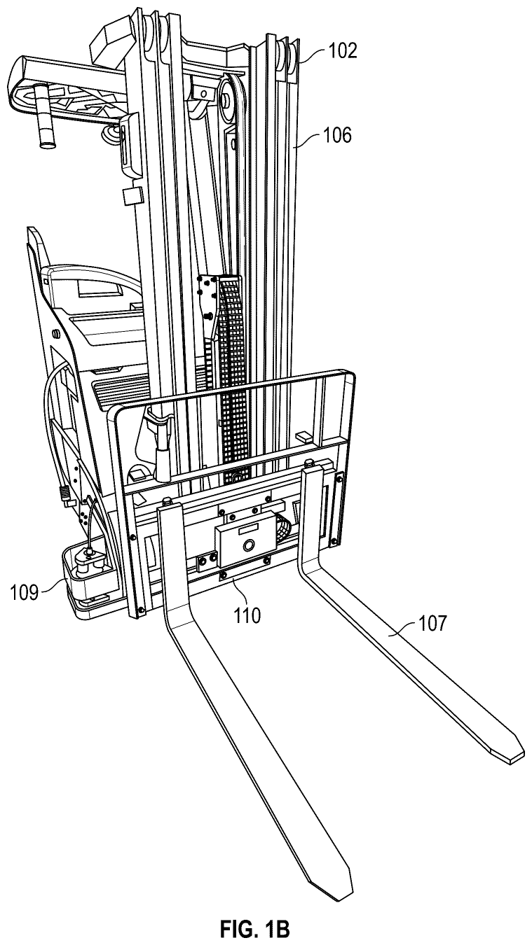

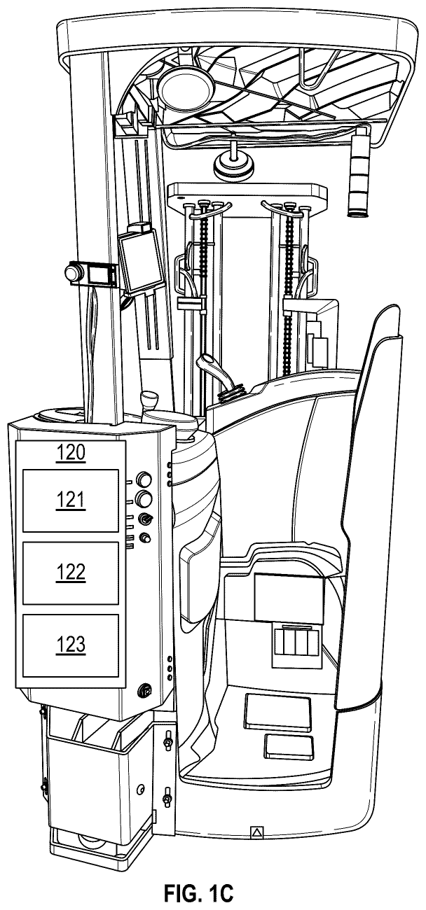

In the following description of FIGS. 1-9, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope of the invention should not be considered limited to the specific arrangement of steps shown in the flowcharts.

In one or more embodiments, this disclosure relates to a deep learning based perception method and system, as well as an automated forklift to which the deep learning based perception system is coupled to.

In one or more embodiments disclosed herein, the forklift is designed to operate as either a manual forklift or a fully autonomous mobile robot (AMR), selecting between these modes with the flip of the switch. Throughout this disclosure, the terms AMR, forklift, and vehicle may be used interchangeably. In the autonomous mode (AMR), a computerized control system senses a plurality of elements within the environment and establishes the drive commands to safely and expeditiously carry out a pallet handling operation. In the AMR mode, the manual controls are ignored. For safety, the operator compartment is monitored, and in case the operator attempts to operate the vehicle while it is in autonomous mode, the vehicle (i.e., forklift) halts.

FIGS. 1A-IC show an automated stand-up counterbalanced three-wheeled forklift vehicle (100), in accordance with one or more embodiments of the invention. The stand-up counterbalanced three-wheeled forklift vehicle is a type of forklift vehicle that comprises a single rear wheel and two front wheels. In one or more embodiments the single rear wheel may serve as a driving force provider, while the two front wheels may serve as stabilizers. Further, the stand-up counterbalanced three-wheeled design of a forklift may enhance the maneuverability of the forklift vehicle to navigate in various environments. For example, the stand-up counterbalanced three-wheeled forklift is able to turn in a narrower space than a four-wheeled forklift.

Turning to FIG. 1A, the forklift (100) includes a vehicle body (101) and a load-handling system (102) that is coupled to the front of the vehicle body (101). An operator's compartment (103) is provided in the center of the vehicle body (101). In one or more embodiments, an operator's compartment (103) may be installed to enable a manual operation of the forklift, in addition to autonomous operations. The operator's compartment may enable the operator to control the forklift in a seating or standing position. Alternatively, in some embodiments, the forklift may be fully autonomous, without the operator's compartment (103).

Additionally, the operator's compartment (103) may include a driver's seat on which the operator of the forklift (100) is seated. Further, the vehicle body (101) has an engine hood and the driver's seat may be positioned on the engine hood. An acceleration pedal may be provided on the floor of the operator's compartment (103) for controlling the speed of the forklift (100).

In one or more embodiments, a manual control system is located in the operator's compartment. Specifically, a steering wheel (108) for steering the forklift (100) may be located in front of the driver's seat. A forward and backward control lever for selecting the forward or backward movement of the forklift (100) may also be located next to the steering wheel (108). A lift control lever for operating the lift cylinders and a tilt control lever for operating the tilt cylinders may also be located next to the steering wheel (108).

In one or more embodiments, a display device (e.g., a monitor) may be located in the operator's compartment (103). The vehicle monitor may have a monitor screen such as an LCD or an EL display, for displaying data obtained by a camera or images generated by a processor. The monitor may be a tablet, a smart phone, a gaming device, or any other suitable smart computing device with a user interface for the operator of the AMR/vehicle. In one or more embodiments, the monitor is used to maneuver and control navigation of the forklift (100).

The vehicle body (101) stands on three wheels. Specifically, the front pair of wheels are drive wheels (104) and the rear pair of wheels are steer wheels (105). The drive wheels (104) provide the power to move the forklift (100) forward or backwards. Further, the drive wheels (104) may move only in two directions (e.g., forward and backward) or turn under a plurality of angles. Additionally, the steering wheels (105) may be responsible for changing the direction of the forklift (100). The steering wheels (105) may be controlled by a steering wheel (108) located in front of the driver's seat. The forklift (100) may be powered by an engine using an internal combustion. The engine may be installed in the vehicle body (101). The vehicle body (101) may include an overhead guard (112) that covers the upper part of the operator's compartment (103).

Further, the load-handling system (102) includes a mast (106). The mast may include inner masts and outer masts, where the inner masts are slidable with respect to the outer masts. In some embodiments, the mast (106) may be movable with respect to the vehicle body (101). The movement of the mast (106) may be operated by hydraulic tilt cylinders positioned between the vehicle body (101) and the mast (106). The tilt cylinders may cause the mast (106) to tilt forward and rearward around the bottom end portions of the mast (106). Additionally, a pair of hydraulically operated lift cylinders may be mounted to the mast (106) itself. The lift cylinders may cause the inner masts to slide up and down relative to the outer masts.

Further, a right and a left fork (107) are mounted to the mast (106) through a lift bracket, which is slidable up and down relative to the inner masts. In one or more embodiments embodiment, the inner masts, the forks (107), and the lift bracket are part of the lifting portion. The lift bracket is shiftable side to side to allow for accurate lateral positioning of the forks and picking of flush pallets. In some embodiments, the lift bracket side shift actuation is performed by hydraulically actuated cylinders, in other embodiments it is driven by electric linear actuators.

In one or more embodiments, a sensing unit (211) may be attached to the vehicle body (101). The sensing unit (211) may include a plurality of sensors including, at least, an Inertial Measurement Unit (“IMU”) and Light Detection and Ranging (“LiDAR.”) The IMU (109) combines a plurality of sensors (e.g., accelerometer, gyroscope, magnetometer, pressure sensor . . . ) to provide data regarding the forklift's (100) orientation, acceleration, and angular velocity. More specifically, the accelerometer of the IMU may measure linear acceleration to determine changes in velocity and direction. Further, the gyroscope of the IMU may measure rotational movements and the magnetometer detects the Earth's magnetic field and to determine orientation information as well as the angle of tilt of the forklift (100).

Further, the LiDAR uses laser light beams to measure the distance between the forklift (100) and surrounding objects. Specifically, the LiDAR emits laser beams and measures the time needed for the beams to bounce back after hitting the target. Based on the measurements, the LiDAR may generate a 3D map of the surrounding environment. The LiDAR may be used to help the forklift (100) to navigate along a path to pick up a pallet from the loading dock of a trailer and to drop them off in a designated spot (a final destination), such as in a warehouse or storage facility. The LiDAR may also be used, during this navigation, to detect and avoid surrounding obstacles (i.e., persons, objects, other forklifts, etc.). In one or more embodiments, there may be two or three LiDAR sensors on the forklift (100). In one or more embodiments, the LiDAR sensors disposed on the forklift (100) may be protected by guards which protrude over and/or surround the LiDAR sensors.

Turning to FIG. 1B, the forklift (100) includes at least one camera (110). The camera (110) may be a line scan or area scan camera, a CCD camera, a CMOS camera, or any other suitable camera used in robotics. The camera (110) may capture images in monochrome or in color. Physically, the camera (110) may be located on the front side of the forklift (100) to be able to capture the position of the forks (107), as well as the surrounding environment that faces the forward movement direction of the forklift. Additionally, one or more cameras may be located on each side of the forklift to monitor the surroundings and potential obstacles. The camera (110) is able to process raw image data, present it on a display, and/or store it in a database. There may be one or more cameras disposed on the forklift (100).

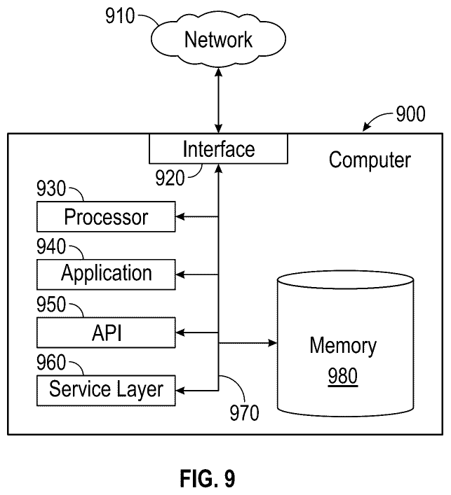

Turning to FIG. 1C, a control system (120) is included at the back part of the forklift (100). The control system may include a microcontroller (121), a battery (122), and a communication module (123). In one or more embodiments, the control system is a PC or computing device such as that shown in FIG. 9. The microcontroller (121) may be one or more of a processor, a Field Programmable Gate Array (FPGA), or other off-the-shelf microcontroller kits that may include open-source hardware or software. The battery (122) may be an extended life battery allowing the robot to operate continuously. The communication module (123) may support one or more of a variety of communication standards such as Wi-Fi, Bluetooth, and other suitable technologies compatible with communicating control and data signals to and from the forklift (100).

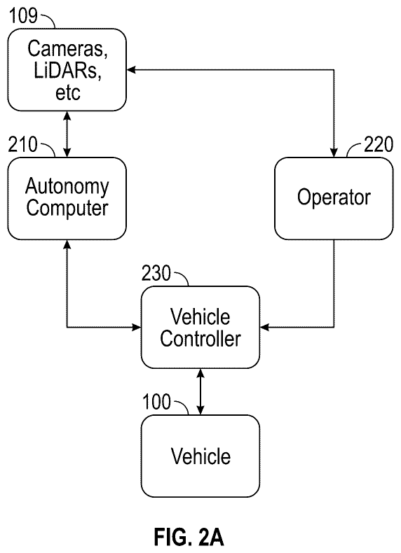

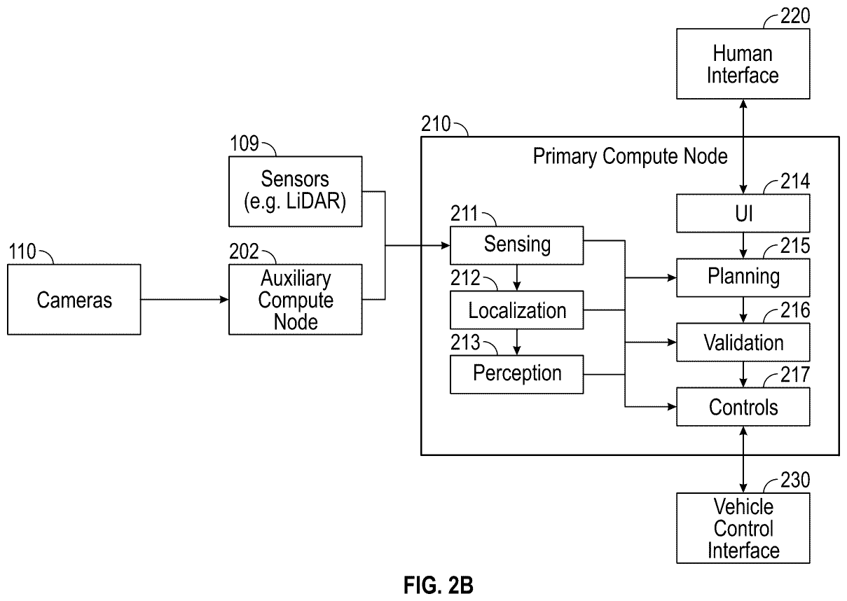

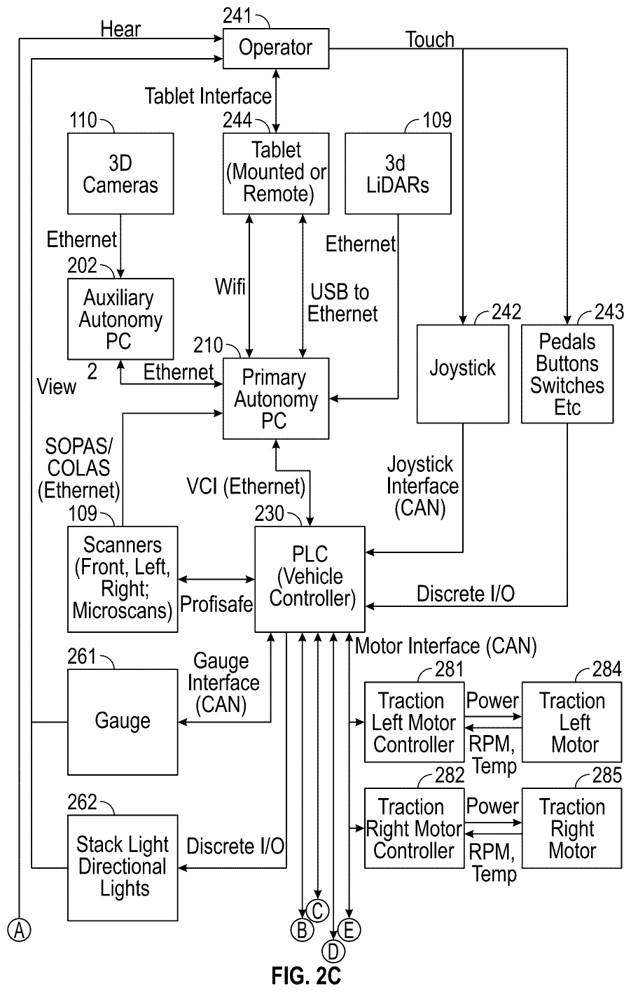

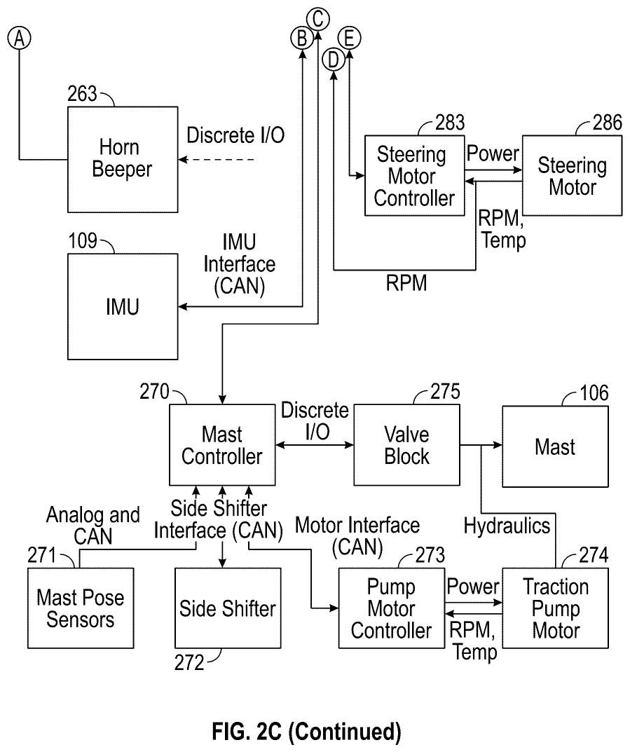

FIG. 2A shows an architecture for two sources of control of the forklift (100). In one or more embodiments, the forklift (100) may be controlled manually and autonomously, as an AMR. Specifically, a human operator (220) may sense the environment directly or remotely. For example, the human operator may interact with the forklift manually while sitting in the operator's compartment (103) and using the wheel, the forward and backward control lever, the lift control lever, and the tilt control lever. Alternatively, the human operator (220) may interact with the forklift (100) remotely. Specifically, the human operator (220) may receive visual input from a camera (110), or a computer-generated image based on the sensors (109) and use this sensor information to navigate the forklift.

In one or more embodiments, an autonomy computer (210) is fed with sensor data (109), as shown on FIG. 2B. The sensor data may be received preprocessed by an auxiliary computer (202), before being inputted into the sensing module (29) of the autonomy computer (210). The auxiliary computer may contain specialized hardware for a deep learning inference analysis. The auxiliary computer (202), the autonomy computer (210), and the vehicle controller (230) may be any suitable computing device, as shown and described in FIG. 9, for example.

Additionally, together with the sensor data (109), the input may be received through the human interface (220). In some embodiments, the human interface (220) may be a ruggedized tablet. The human interface may display information to the operator and serves as an interface from which an operator determines the task for the forklift (100) to perform. The human interface (220) is detachable from the forklift (100) to allow issuing commands or monitoring of operation by a person remotely, outside of the operator's compartment (103). Additionally, issuing the commands may be accomplished through an application programming interface (API) to allow integration with a facility's warehouse management system (WMS).

Continuing with FIG. 2B, the autonomy computer (210) includes a plurality of modules, including a sensing module (29), a localization module (212), a perception module (213), a user interface module (214), a planning module (215), a validation module (216), and a controls module (217). The autonomy computer analyses the input data and based on the analysis generates commands transmitted to the vehicle controller (230) (e.g., unloading a trailer).

More specifically, the sensing module (29) collects the input data from various sensor sources (109) and time-correlating the input data, to enable other modules to operate based on the output, which is a coherent view of the environment at one instant in time.

Further, the localization module (212) is responsible for the simultaneous localization of the robot and mapping of its environment, based on, at least, the data obtained by the sensing module (29). The mapping process may be supplemented by measurements recorded during a site survey. The localization may include determining the position and orientation of the forklift (100). Specifically, the IMU data may be used to determine the forklift's acceleration and rotation movements, as well as the tilt of the forklift (100).

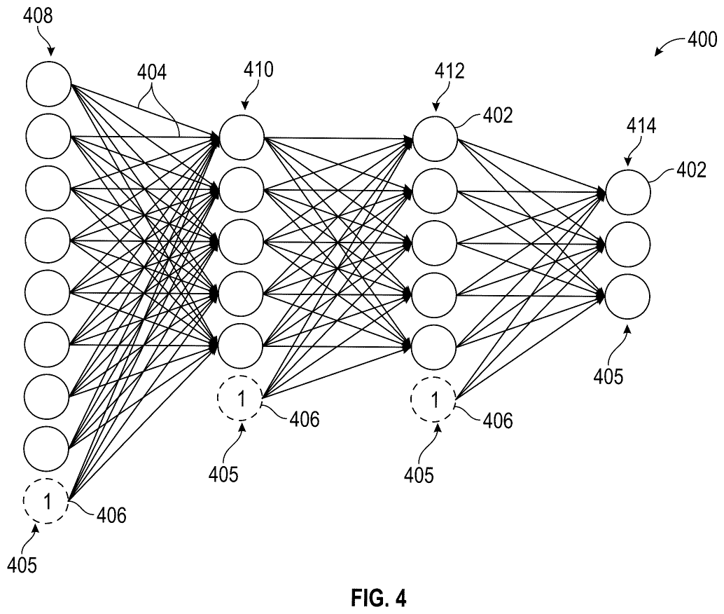

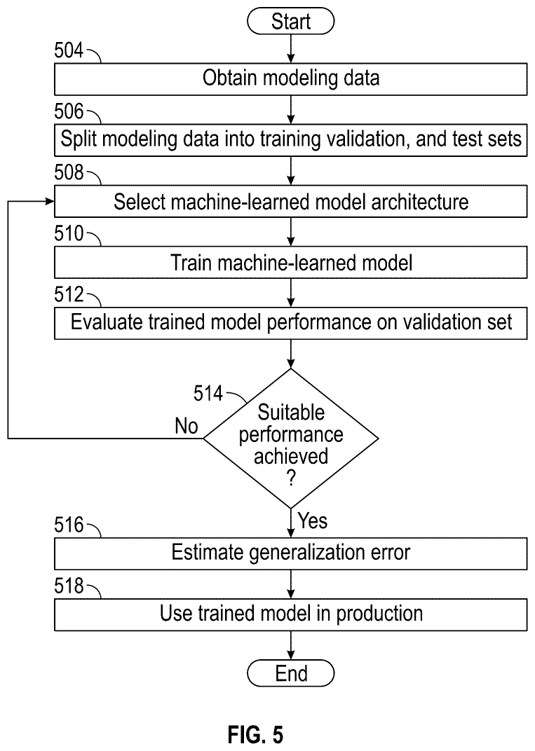

The perception module (213) analyzes and contextualizes the sensor data and identifies key objects within the environment, such as pallets and trailers. The identification is accomplished with a combination of classical and neural network-based approaches, further explained in FIGS. 4 and 5. Specifically, the perception module uses the machine learning model and the obtained data to determine the location of an entrance door to storage, a plurality of pallets' face-side pockets, and a plurality of pallets' face-side pockets.

The user interface (“UI”) module (214) may be responsible for interfacing with the human interface module (220). The UI module (214) may notify the human interface module about the status of the forklift (100), including the location, orientation, tilt, battery level, warning, failures, etc. Further, the UI module (214) may receive a plurality of tasks from the human interface module (220).

Further, the planning module (215) is responsible for executing the deliberative portions of the forklift's (100) task planning. Initially, the planning module (215) determines what action primitive should be executed next in order to progress towards a goal. Specifically, the action primitive refers to an elementary action performed by the forklift (100) that builds towards a more complex behavior or task, such as picking a pallet as a primitive that works towards unloading a truck. Further, the planning module (215) employs a hybrid search, sampling, and optimization-based path planner to determine a path that most effectively accomplishes a task, such as adjusting a configuration of a plurality of forks based on the determined position of the plurality of fork with respect to the plurality of pallets' face-side pockets and determining a final position of the pallet using the machine learning model based on the obtained data.

Additionally, the validation planning module (216) is a reactive planning component which runs at a higher frequency than the planning module (215). The validation planning module (216) avoids near-collisions that would cause the vehicle controller (230) to issue a protective stop. Further, the validation planning module (216) is also responsible for determining any aspects of the plan that were not specified by the slower-running planning loop (e.g., load exact mast poses that cannot be known until the forklift is about to execute a pick or place action).

Additionally, the controls module (217) is a soft real-time component that follows the refined plan that was emitted by the validation planning module (216). The controls module (217) module is responsible for closing any gap that arises from the difference between a planned motion and the motion that is carried out, due to real-world imprecisions in vehicle control.

The autonomy computer (210) and the human interface (220) are two control sources that feed into the vehicle controller (230). The vehicle controller (230) analyses the control inputs that it receives to enforce safety prerequisites of the operation of the forklift. In autonomous mode, the analysis includes monitoring for any potential collisions, which are detected through sensors that communicate directly with the vehicle controller (230). After the commands have been validated, they are forwarded to the discrete controllers that execute the commanded motion.

In one or more embodiments, the vehicle controller (230) may employ an input-process-output model. The vehicle controller (230) receives a plurality of inputs from a plurality of sensors and controllers. More specifically, the status of each of the motors of the forklift (100) may be monitored via a motor controller, which reports to the vehicle controller (230) via a controller area network (“CAN”) bus (not shown). Further, the status of the mast is monitored by a discrete controller, which also reports via a CAN bus. The input from the user may be received through a user interface or a joystick that is also connected via a CAN bus. In some embodiments, the user interface inputs (e.g., button and switch inputs) are received through safety-rated and non-safety-rated inputs, as appropriate for the type of signal they represent.

Further, the commands from the autonomy computer (210) may be received via a direct ethernet link using a combination of transmission control protocol (“TCP”) and user datagram protocol (“UDP”). Additionally, the sensors used to monitor the forklift's environment may report information through safety-rated protocols built on TCP and UDP.

Additionally, the vehicle controller (230) may process the data in two sub-modules including a main program and a safety program. Specifically, the main program processes the majority of the tasks. Within this program, the vehicle controller establishes the state of the forklift (100) and determines what commands should be sent to controllers. Further, the diagnostic and reporting of the information is handled in this program and further transmitted or recorded.

The safety program provides a safety guarantee of the vehicle controller are enforces the guarantee. For example, the user interface may employ stop buttons to stop the forklift's (100) motion in both, autonomous and manual, modes. Additionally, the forklift may have a physical button to stop the forklift's operation. The safety program is much less expressive as a programming environment, and as a result, it is much simpler to analyze, allowing it to be used as the foundation of safety features of the forklift (100).

In one or more embodiments, the vehicle controller (230) has a plurality of outputs including commands for motor performance and commands for mast performance, both sent via the CAN bus and information regarding the status of the vehicle sent to the primary autonomy computing node via TCP and UDP. Further, the vehicle controller (230) transmits discrete controls using safety-rated and non-safety-rated outputs. Therefore, a redundant safety-rated relay is used as motive power to the forklift (100) and is controlled via a safety-rated output. The safety-rated outputs are controlled directly by the safety program.

FIG. 2C shows components of the forklift system (100) and their interconnections. Specifically, the manual mode includes an operator (241) controlling the forklift directly through a joystick (242) or physical buttons, pedals, switches, etc. (243) Additionally, the operator (241) may interact with an operator's tablet (244) to directly control the forklift (100) or to assign tasks to the forklift (100). The assigned tasks are carried out by the autonomy computer (210) which utilizes the machine learning models to generate autonomous instructions for the forklift (100). The autonomy computer (210) generates the instructions based on the input received from the camera (110) through the auxiliary autonomy computer (202), sensors (109), and the operator's tablet (244), which may be connected to the autonomy computer (210) through an ethernet cable or wirelessly.

The outputs of the autonomy computer (210), joystick (242), physical buttons, pedals, and switches, (243), as well as the sensors (109), are used as input to a vehicle controller (230). The vehicle controller interfaces with traction left (281) and right (282) motor controllers controlling traction left motor (284) and traction right motor (285), and a steering motor controller (283) controlling the steering motor (286).

Additionally, the vehicle controller (230) interfaces with the mast controller (270) which receives input from mast pose sensors (271) and interfaces with controllers controlling the movement of the mast (106) and forks (107) including a side shifter (272), a pump motor controller (273), a traction pump motor (274), a valve block (275), and the mast (106).

The vehicle controller (230) may notify the operator (241) about the state of the forklift using a gauge (261) consisting of stacked lights (262) with a plurality of colors, where each color combination represents a different predefined message to the operator (241) and a horn beeper (263) which is used in a case of an alarm.

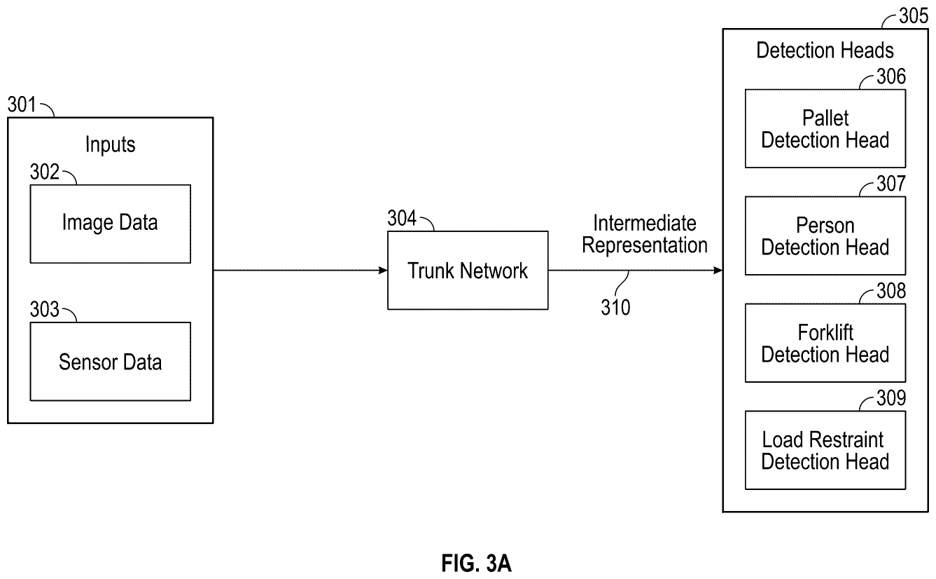

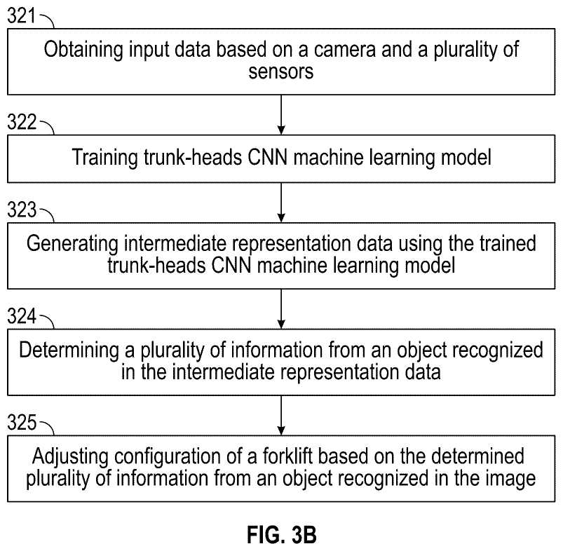

FIG. 3A shows a diagram in accordance with one or more embodiments. Specifically, the diagram illustrates an architecture for deep learning-based perception. Further, one or more blocks in FIG. 3 may be performed by one or more components as described in FIGS. 1 and 2.

In one or more embodiments, input data (301) is obtained using a camera (110) and sensors (109). The camera (110) may be a part of a bigger manual or automatic system, such as the forklift camera. The obtained raw image data (302) may be, at least, a binary image, a monochrome image, a color image, or a multispectral image. The image data (302) values, expressed in pixels, may be combined in various proportions to obtain any color in a spectrum visible to the human eye. In one or more embodiments, the image data (302) may have been captured and stored in a non-transient computer-readable medium as described in FIG. 9. The captured image may be of any resolution. Further, the video is determined to be a sequence of images played at a predetermined frequency, which is expressed by frames per second. Further, the videos are processed by extracting frames as images and processing them independently of each other.

Additionally, the forklift (100) utilizes a plurality of sensors in real time to obtain sensor data (303). More specifically, the forklift (100) logs its position, orientation, tilt, and speed using the IMU. Additionally, the forklift (100) uses LiDAR to scan its surroundings and map all potential obstacles in its environment. In one or more embodiments, the forklift (100) may adjust the scanning of the environment in response to control signaling from the operator to regulate the scanning.

The input data (301) is processed by a trunk network (304). The trunk network (304) includes learning general representations for holistic images. Specifically, the trunk network (304) may represent the main body of the convolutional neural network (CNN), responsible for extracting features and representations from the input data (301).

In one or more embodiments, the extraction process may include passing the image data (301) through multiple layers to gradually transform the image data (301) into a hierarchy of features. Initial layers may focus on determining more simple features such as lines and edges and deeper layers may determine more complex and abstract features enabling recognition of patterns and objects within the input data.

In one or more embodiments, the initial layers may be the convolutional layers, consisting of multiple filters that extract features such as lines, edges, texture, or simple patterns. The convolutional layers may determine the features by computing dot product between the filter and the input patch of pixels. Further, after convolution, an activation function is applied to the computed the dot product values determining areas, in the form of a feature map, where the convolutional layer learned a pattern or the feature. Further, the feature maps may be down-sampled to reduce their spatial dimensions while retaining the most important information.

In one or more embodiments, the above layers may be stacked on top of each other more than one time, creating a network that consists of multiple convolutional and pooling layers. Such network creates a hierarchy of features where deeper layers may capture more abstract and high-level features. Additionally, the fully connected layers may combine extracted features from previous layers to generate an intermediate representation data (310) including recognized patterns and objects in the input data (301).

In one or more embodiments, the intermediate representation data is inputted into a plurality of detection heads (305). Specifically, each detection head may be specialized to detect a certain component such as, at least, a pallet detection head (306), a person detection head (307), a forklift detection head (308), and a load restraint detection head (309). Additionally, the plurality of detection heads may include a pallet pocket detection head.

In one or more embodiments, the detection heads may use a machine learning model based on the You Look Only Once (YOLO) algorithm. The YOLO object detection algorithm is a type of Convolutional Neural Network (CNN) that classifies and localizes predetermined components, such as the pallet, the person, the forklift, or the truck. The YOLO divides each image into S×S grids and calculates the reliability of the grids. The reliability reflects accuracy upon recognition of the object in the grids. Initially, the bounding box may be set irrelevant to the object recognition. When the position of the bounding box is adjusted by calculating the reliability, the bounding box having the highest accuracy on the object recognition may be obtained. An object class score is calculated to calculate whether an object is included in the grids. As a result, the object of total S×S×N may be estimated, and the output of the model is the information on an object recognized in the image. Most of the grids have low reliability. Neighboring grids may be combined to increase the reliability. Then, a threshold may be set to remove an unnecessary part. The YOLO is very fast with simple processing, in which the performance is twice as high as other real-time vision technologies. This is because classes are classified by looking at the whole image at once.

Further, in one or more embodiments, an upgraded version of YOLO may be used, such as YOLOv2. The YOLOv2 comprises a deeper architecture with 19 convolutional layers and 5 max-pooling layers to capture more complex multi-level features from the input data (301). Further, YOLOv2 includes multiple sets of anchor boxes that vary in scale and aspect ratios to effectively detect and localize objects with diverse shapes and proportions. Additionally, YOLOv2 implements multi-scale training enabling the model to learn from images of different sizes, allowing a recognition and localization of objects regardless of their scale.

FIG. 3B shows a flowchart in accordance with one or more embodiments. Specifically, the flowchart illustrates a method for deep learning-based perception. Further, one or more blocks in FIG. 3B may be performed by one or more components as described in FIGS. 1, 2, and 3A. While the various blocks in FIG. 3B are presented and described sequentially, one of ordinary skill in the art will appreciate that some or all of the blocks may be executed in a different order, may be combined or omitted, and some or all of the blocks may be executed in parallel. Furthermore, the blocks may be performed actively or passively.

In Step 8321, data is obtained using a camera (110) and sensors (109). The camera (110) may be a part of a bigger manual or automatic system, such as the forklift camera. The obtained raw image data may be, at least, a binary image, a monochrome image, a color image, or a multispectral image. The image data values, expressed in pixels, may be combined in various proportions to obtain any color in a spectrum visible to the human eye. In one or more embodiments, the image data may have been captured and stored in a non-transient computer-readable medium as described in FIG. 9. The captured image may be of any resolution. Further, the video is determined to be a sequence of images played at a predetermined frequency, which is expressed by frames per second. Further, the videos are processed by extracting frames as images and processing them independently of each other.

Additionally, the forklift (100) utilizes a plurality of sensors in real time. More specifically, the forklift (100) logs its position, orientation, tilt, and speed using the IMU. Additionally, the forklift (100) uses LiDAR to scan its surroundings and map all potential obstacles in its environment. In one or more embodiments, the forklift (100) may adjust the scanning of the environment in response to control signaling from the operator to regulate the scanning.

In Step S322, trunk-head CNN models are trained based on the previously obtained historical data using machine learning algorithms obtained in previous interactions between the forklift and its surroundings. The historical data are used as training data and validation data to train and validate the trunk-head CNN machine learning models. Machine learning (ML), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein. However, one skilled in the art will recognize that the concepts and methods detailed hereafter are not limited by this choice of nomenclature.

Machine-learned model types may include, but are not limited to, generalized linear models, Bayesian regression, random forests, and deep models such as neural networks, convolutional neural networks, and recurrent neural networks. Machine-learned model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a machine-learned model is referred to as selecting the model “architecture.” Once a machine-learned model type and hyperparameters have been selected, the machine-learned model is trained to perform a task.

Herein, a cursory introduction to various machine-learned models such as a neural network (NN) and convolutional neural network (CNN) are provided as these models are often used as components—or may be adapted and/or built upon—to form more complex models such as autoencoders and diffusion models. However, it is noted that many variations of neural networks, convolutional neural networks, autoencoders, transformers, and diffusion models exist. Therefore, one with ordinary skill in the art will recognize that any variations to the machine-learned models that differ from the introductory models discussed herein may be employed without departing from the scope of this disclosure. Further, it is emphasized that the following discussions of machine-learned models are basic summaries and should not be considered limiting.

A diagram of a neural network is shown in FIG. 4. At a high level, a neural network (400) may be graphically depicted as being composed of nodes (402), where here any circle represents a node, and edges (404), shown here as directed lines. The nodes (402) may be grouped to form layers (405). FIG. 4 displays four layers (408, 410, 412, 414) of nodes (402) where the nodes (402) are grouped into columns, however, the grouping need not be as shown in FIG. 4. The edges (404) connect the nodes (402). Edges (404) may connect, or not connect, to any node(s) (402) regardless of which layer (405) the node(s) (402) is in. That is, the nodes (402) may be sparsely and residually connected. A neural network (400) will have at least two layers (405), where the first layer (408) is considered the “input layer” and the last layer (414) is the “output layer.” Any intermediate layer (410, 412) is usually described as a “hidden layer.” A neural network (400) may have zero or more hidden layers (410, 412) and a neural network (400) with at least one hidden layer (410, 412) may be described as a “deep” neural network or as a “deep learning method.” In general, a neural network (400) may have more than one node (402) in the output layer (414). In this case the neural network (400) may be referred to as a “multi-target” or “multi-output” network.

Nodes (402) and edges (404) carry additional associations. Namely, every edge is associated with a numerical value. The edge numerical values, or even the edges (404) themselves, are often referred to as “weights” or “parameters.” While training a neural network (400), numerical values are assigned to each edge (404). Additionally, every node (402) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad ( 2 )$$

where i is an index that spans the set of “incoming” nodes (402) and edges (404) and ƒ is a user-defined function. Incoming nodes (402) are those that, when viewed as a graph (as in FIG. 4), have directed arrows that point to the node (402) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (402) in a neural network (400) may have a different associated activation function. Often, as a shorthand, activation functions are described by the function ƒ by which it is composed. That is, an activation function composed of a linear function ƒ may simply be referred to as a linear activation function without undue ambiguity.

When the neural network (400) receives an input, the input is propagated through the network according to the activation functions and incoming node (402) values and edge (404) values to compute a value for each node (402). That is, the numerical value for each node (402) may change for each received input. Occasionally, nodes (402) are assigned fixed numerical values, such as the value of 1, that are not affected by the input or altered according to edge (404) values and activation functions. Fixed nodes (402) are often referred to as “biases” or “bias nodes” (406), displayed in FIG. 4 with a dashed circle.

In some implementations, the neural network (400) may contain specialized layers (405), such as a normalization layer, or additional connection procedures, like concatenation. One skilled in the art will appreciate that these alterations do not exceed the scope of this disclosure.

As noted, the training procedure for the neural network (400) comprises assigning values to the edges (404). To begin training the edges (404) are assigned initial values. These values may be assigned randomly, assigned according to a prescribed distribution, assigned manually, or by some other assignment mechanism. Once edge (404) values have been initialized, the neural network (400) may act as a function, such that it may receive inputs and produce an output. As such, at least one input is propagated through the neural network (400) to produce an output. Training data is provided to the neural network (400). Generally, training data consists of pairs of inputs and associated targets. The targets represent the “ground truth,” or the otherwise desired output, upon processing the inputs. During training, the neural network (400) processes at least one input from the training data and produces at least one output. Each neural network (400) output is compared to its associated input data target. The comparison of the neural network (400) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (400) output and the associated target. The loss function may also be constructed to impose additional constraints on the values assumed by the edges (404), for example, by adding a penalty term, which may be physics-based, or a regularization term. Generally, the goal of a training procedure is to alter the edge (404) values to promote similarity between the neural network (400) output and associated target over the training data. Thus, the loss function is used to guide changes made to the edge (404) values, typically through a process called “backpropagation.”

While a full review of the backpropagation process exceeds the scope of this disclosure, a brief summary is provided. Backpropagation consists of computing the gradient of the loss function over the edge (404) values. The gradient indicates the direction of change in the edge (404) values that results in the greatest change to the loss function. Because the gradient is local to the current edge (404) values, the edge (404) values are typically updated by a “step” in the direction indicated by the gradient. The step size is often referred to as the “learning rate” and need not remain fixed during the training process. Additionally, the step size and direction may be informed by previously seen edge (404) values or previously computed gradients. Such methods for determining the step direction are usually referred to as “momentum” based methods.

Once the edge (404) values have been updated, or altered from their initial values, through a backpropagation step, the neural network (400) will likely produce different outputs. Thus, the procedure of propagating at least one input through the neural network (400), comparing the neural network (400) output with the associated target with a loss function, computing the gradient of the loss function with respect to the edge (404) values, and updating the edge (404) values with a step guided by the gradient, is repeated until a termination criterion is reached. Common termination criteria are reaching a fixed number of edge (404) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (404) values are no longer intended to be altered, the neural network (400) is said to be “trained.”

One or more embodiments disclosed herein employ a convolutional neural network (CNN). A CNN is similar to a neural network (400) in that it can technically be graphically represented by a series of edges (404) and nodes (402) grouped to form layers. However, it is more informative to view a CNN as structural groupings of weights; where here the term structural indicates that the weights within a group have a relationship. CNNs are widely applied when the data inputs also have a structural relationship, for example, a spatial relationship where one input is always considered “to the left” of another input. Grid data, which may be three-dimensional, has such a structural relationship because each data element, or grid point, in the grid data has a spatial location (and sometimes also a temporal location when grid data is allowed to change with time). Consequently, a CNN is an intuitive choice for processing grid data.

A structural grouping, or group, of weights is herein referred to as a “filter”. The number of weights in a filter is typically much less than the number of inputs, where here the number of inputs refers to the number of data elements or grid points in a set of grid data. In a CNN, the filters can be thought as “sliding” over, or convolving with, the inputs to form an intermediate output or intermediate representation of the inputs which still possesses a structural relationship. Like unto the neural network (400), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (400) to produce a final output. Note, that in this context, the neural network (400) is still considered part of the CNN. Like unto a neural network (400), a CNN is trained, after initialization of the filter weights, and the edge (404) values of the internal neural network (400), if present, with the backpropagation process in accordance with a loss function.

A common architecture for CNNs is the so-called “U-net.” The term U-net is derived because a CNN after this architecture is composed of an encoder branch and a decoder branch that, when depicted graphically, often form the shape of the letter “U.” Generally, in a U-net type CNN the encoder branch is composed of N encoder blocks and the decoder branch is composed of N decoder blocks, where N≥1. The value of N may be considered a hyperparameter that can be prescribed by user or learned (or tuned) during a training and validation procedure. Typically, each encoder block and each decoder block consist of a convolutional operation, followed by an activation function and the application of a pooling (i.e., downsampling) or upsampling operation. Further, in a U-net type CNN each of the N encoder and decoder blocks may be said to form a pair. Intermediate data representations output by an encoder block may be passed to, and often concatenated with other data, an associated (i.e., paired) decoder block through a “skip” connection or “residual” connection.

Another type of machine-learned model is a transformer. A detailed description of a transformer exceeds the scope of this disclosure. However, in summary, a transformer may be said to be deep neural network capable of learning context among data features. Generally, transformers act on sequential data (such as a sentence where the words form an ordered sequence). Transformers often determine or track the relative importance of features in input and output (or target) data through a mechanism known as “attention.” In some instances, attention mechanism may further be specified as “self-attention” and “cross-attention,” where self-attention determines the importance of features of a data set (e.g., input data, intermediate data) relative to other features of the data set. For example, if the data set is formatted as a vector with M elements, then self-attention quantifies a relationship between the M elements. In contrast, cross-attention determines the relative importance of features to each other between two data sets (e.g., an input vector and an output vector). Although transformers generally operate on sequential data composed of ordered elements, transformers do not process the elements of the data sequentially (such as in a recurrent neural network) and require an additional mechanism to capture the order, or relative positions, of data elements in a given sequence. Thus, transformers often use a positional encoder to describe the position of each data element in a sequence, where the positional encoder assigns a unique identifier to each position. A positional encoder may be used to describe a temporal relationship between data elements (i.e., time series) or between iterations of a data set when a data set is processed iteratively (i.e., representations of a data set at different iterations). While concepts such as attention and positional encoding were generally developed in the context of a transformer, they may be readily inserted into—and used with—other types of machine-learned models (e.g., diffusion models).

FIG. 5 depicts a general framework for training and evaluating a machine-learned model. Herein, when training a machine-learned model, the more general term “modeling data” will be adopted as opposed to training data to refer to data used for training, evaluating, and testing a machine-learned model. Further, use of the term modeling data prevents ambiguity when discussing various partitions of modeling data such as a training set, validation set, and test set, described below. In the context of FIG. 5, modeling data will be said to consist of pairs of inputs and associated targets. When a machine-learned model is trained using pairs of inputs and associated targets, that machine-learned model is typically categorized as a “supervised” machine-learned model or a supervised method. In the literature, autoencoders are often categorized as “unsupervised” or “semi-supervised” machine learning models because modeling data used to train these models does not include distinct targets. For example, in the case of autoencoders, the output, and thus the desired target, of an autoencoder is the input. That said, while autoencoders may not be considered supervised models, the training procedure depicted in FIG. 5 may still be applied to train autoencoders where it is understood that an input-target pair is formed by setting the target equal to the input.

To train a machine-learned model, modeling data must be provided. In accordance with one or more embodiments, modeling data may be collected from existing images of forklift's environment such as a warehouse, a trailer, or any other storage facility, as well as the obstacles including other forklifts, humans, walls, and misplaced equipment. Further, the data about the components of the forklift such as the forks may be supplied to the machine-learning model. In one or more embodiments, modeling data is synthetically generated, for example, by artificially constructing the environment or the forklift's components. This is to promote robustness in the machine-learned model, such that it is generalizable to new environments, components and input data unseen during training and evaluation.

Keeping with FIG. 5, in Block 504, modeling data is obtained. As stated, the modeling data may be acquired from historical datasets, be synthetically generated, or may be a combination of real and synthetic data. In Block 506, the modeling data is split into a training set, validation set, and test set. In one or more embodiments, the validation and the test set are the same such that the modeling data is effectively split into a training set and a validation/testing set. In Block 508, given the machine-learned model type, (e.g., autoencoder) an architecture (e.g., number of layers, compression ratio, etc.) is selected. In accordance with one or more embodiments, architecture selection is performed by cycling through a set of user-defined architectures for a given model type. In other embodiments, the architecture is selected based on the performance of previously evaluated models with their associated architectures, for example, using a Bayesian-based search. In Block 510, with an architecture selected, the machine-learned model is trained using the training set. During training, the machine-learned model is adjusted such that the output of the machine-learned model, upon receiving an input, is similar to the associated target (or, in the case of an autoencoder, the input). Once the machine-learned model is trained, in Block 512, the validation set is processed by the trained machine-learned model and its outputs are compared to the associated targets. Thus, the performance of the trained machine-learned model can be evaluated. Block 514 represents a decision. If the trained machine-learned model is found to have suitable performance as evaluated on the validation set, where the criterion for suitable performance is defined by a user, then the trained machine-learned model is accepted for use in a production (or deployed) setting. As such, in Block 518, the trained machine-learned model is used in production. However, before the machine-learned model is used in production a final indication of its performance can be acquired by estimating the generalization error of the trained machine-learned model, as shown in Block 516. The generalization error is estimated by evaluating the performance of the trained machine-learned model, after a suitable model has been found, on the test set. One with ordinary skill in the art will recognize that the training procedure depicted in FIG. 5 is general and that many adaptions can be made without departing from the scope of the present disclosure. For example, common training techniques, such as early stopping, adaptive or scheduled learning rates, and cross-validation may be used during training without departing from the scope of this disclosure.

Turning back to FIG. 3, in Step 8323, after training the Trunk-Heads Machine learning model, the input data (301) is processed by a trunk network (304) to generate an intermediate representation data (310). Specifically, the trunk network (304) may represent the main body of the convolutional neural network (CNN), responsible for extracting features and representations from the input data (301). In one or more embodiments, the extraction process may include passing the image data (301) through multiple layers to gradually transform the image data (301) into a hierarchy of features. Initial layers, such as convolutional layers, may focus on determining more simple features such as lines and edges and deeper layers, such as pooling layers, may determine more complex and abstract features enabling recognition of patterns and objects within the input data.

Further, multiple convolutional and pooling layers may be stacked on top of each other creating a network. Such network creates a hierarchy of features where deeper layers may capture more abstract and high-level features. Additionally, the fully connected layers may combine extracted features from previous layers to generate an intermediate representation data (310) including recognized patterns and objects in the input data (301).

In Step 8324, the intermediate representation data is inputted into a plurality of detection heads (305) to determine output information on an object recognized in the image. Specifically, each detection head may be specialized to detect a certain component such as, at least, a pallet detection head (306), a person detection head (307), a forklift detection head (308), and a load restraint detection head (308). The detection heads employ a machine learning model based on You Look Only Once (YOLO) algorithm. The YOLO object detection algorithm classifies and localizes predetermined components, such as the pallet, the person, the forklift, or the truck.

Further, in one or more embodiments, the output information may contain more information than just recognizing the object in the input image (302). Specifically, after detecting a pallet, the pallet prediction head (306), may determine information about the object, such as, pallet-face corners, pallet-face pocket corners, whether the face is the short or long side of the pallet, and the type of supports (e.g., stringer or block) used by the pallet.

In Step S305, the configuration of the forklift is adjusted based on the information on the object recognized in the image. In one or more embodiments, the configuration of the fork may represent adjustment of the fork and the mast with respect to the vehicle body (101). The configuration of the fork may have three degrees of freedom, including lift, tilt, and side shift. In some embodiments, the side shift may be adjusted using linear actuators to shift the carriage left or right. Additionally, the configuration of the fork may include a fourth degree of freedom including spread. Specifically, the spread of the fork represents the distance between the two tines of the fork.

Specifically, detecting multiple information regarding the input image may be important for reliably picking pallets. Further, the input image data (302) may be used together with sensor data (303) to generate more precise and robust results. Specifically, the corner detections may be matched to the lidar sensor data (303) to estimate the pose of the pallet relative to the robot. Further, the pocket corners may estimate where the forks may be placed without colliding with the pallet. Knowing which face of the pallet is the long face and which is the short is important for deciding how to place the pallet in tight spaces and how to place several pallets in a desired pattern. Having the support type is important for planning paths that avoid collisions between the robot forks and the pallet, particularly, while the forks are being inserted into the pallet during a pallet pick operation.

Further, the information regarding the input image is important for inferring the approximate location of the forks on the neighboring forklifts. This will help the forklift avoid collisions with other forklifts because the forklift cannot completely rely on 2D planar lidar sensors to detect forks of the forklift, since the forks may be held below or above the plane in which the lidar is able to detect obstacles.

Additionally, the forks may be placed on the forklift using several specific mounting points. The information regarding the input image may be used to determine which mounting points are being used. This is important for reliably picking pallets since certain pallets (e.g., turned stringer pallets) may only be picked with a specific configuration of the forks.

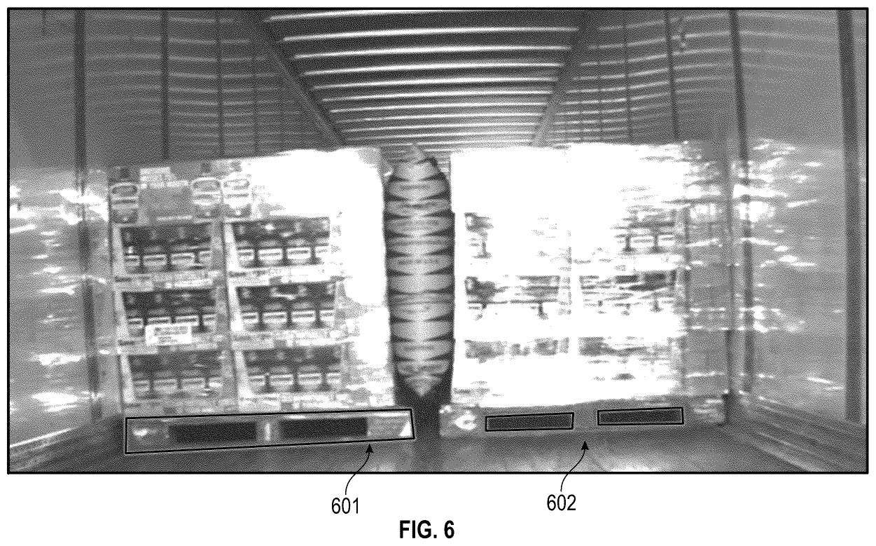

FIG. 6 shows a machine learning model's recognition of a pallet and pallet's face-side pockets. As described above, the machine learning model determines a pallet (601) and pallets' face-side pockets (602) based on the continuous stream of images. The pallet's face-side pockets are holes located on the vertical side of the pallet facing the entrance of the storage. As shown in FIG. 6, the autonomy computer (210) uses a machine learning model to determine the pallet (601). Further, after locating the pallets (601), the autonomy computer (210) determines two gaps within the face side of the pallet (601), the gaps representing the pallet's face pockets (602).

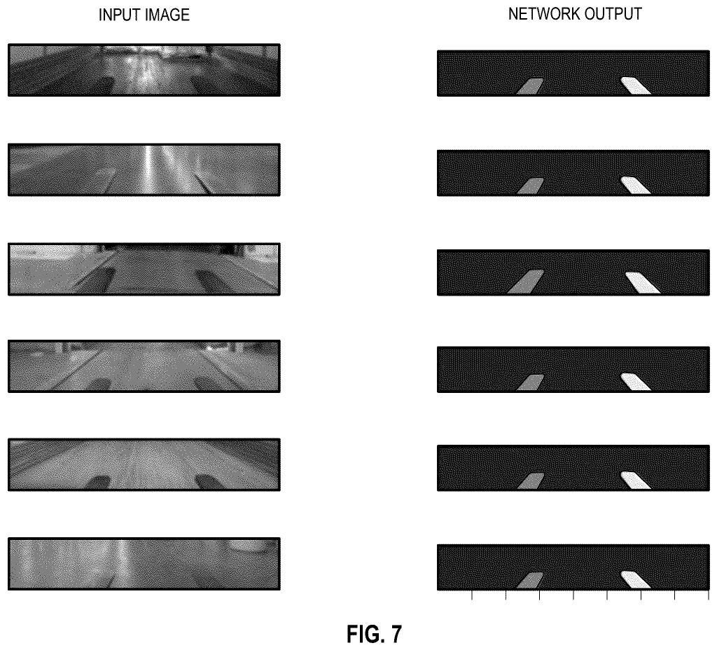

In one or more embodiments, a configuration of the forks may be adjusted based on the determined information regarding the input image. After locating the pallet face-side pockets (602), the forklift needs to adjust the configuration of the forks (107) to fit inside the pallet face-side pockets (602). As shown in FIG. 7, the machine learning model recognizes a left and a right fork. A real-time position of the fork (107) and the pallet face-side pockets (602) are continuously compared to ensure an appropriate lifting position. The forks (107) may be configured to move up and down, left and right, as well as to be tilted at an angle.

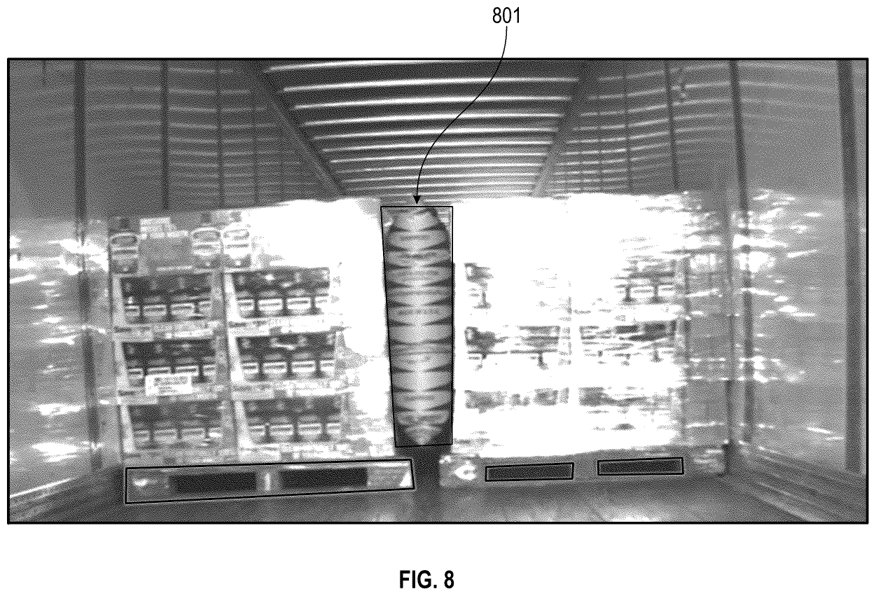

As shown in FIG. 8, information regarding the input includes information regarding the detected load restraints (801). The load restraints (801) may include dunnage air bags, restraint bars, restraint straps, and cardboard dunnage. The load restraints (801) are important for safe transportation and storage. The autonomous forklift (100) may be configured to require the operator's assistance with removing the load restraints (801) prior to unloading the pallets to prevent unsafe situations. Additionally, during the unloading phase, the automated forklift (100) may require detecting the load restraints (801) using a load restraint detection head and removing the load restraints (801) before continuing with the unloading process. Further, during the loading phase, the automated forklift (100) may require detecting the load restraints (801) using a load restraint detection head before continuing with the unloading process.

Embodiments disclosed herein may be implemented on any suitable computing device, such as the computer system shown in FIG. 9. Specifically, FIG. 9 is a block diagram of a computer system (900) used to provide computational functionalities associated with described algorithms, methods, functions, processes, flows, and procedures as described in the instant disclosure, according to an implementation. The illustrated computer (900) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (900) may include a computer that includes an input device, such as a keypad, keyboard, touch screen, or other device that can accept user information, and an output device that conveys information associated with the operation of the computer (900), including digital data, visual, or audio information (or a combination of information), or a GUI.

The computer (900) can serve in a role as a client, network component, a server, a database or other persistency, or any other component (or a combination of roles) of a computer system for performing the subject matter described in the instant disclosure. The illustrated computer (900) is communicably coupled with a network (910). In some implementations, one or more components of the computer (900) may be configured to operate within environments, including cloud-computing-based, local, global, or other environment (or a combination of environments).

At a high level, the computer (900) is an electronic computing device operable to receive, transmit, process, store, or manage data and information associated with the described subject matter. According to some implementations, the computer (900) may also include or be communicably coupled with an application server, e-mail server, web server, caching server, streaming data server, business intelligence (BI) server, or other server (or a combination of servers).

The computer (900) can receive requests over network (910) from a client application (for example, executing on another computer (900) and responding to the received requests by processing the said requests in an appropriate software application. In addition, requests may also be sent to the computer (900) from internal users (for example, from a command console or by other appropriate access method), external or third-parties, other automated applications, as well as any other appropriate entities, individuals, systems, or computers.

Each of the components of the computer (900) can communicate using a system bus (970). In some implementations, any or all of the components of the computer (900), both hardware or software (or a combination of hardware and software), may interface with each other or the interface (920) (or a combination of both) over the system bus (970) using an application programming interface (API) (950) or a service layer (960) (or a combination of the API (950) and service layer (960). The API (950) may include specifications for routines, data structures, and object classes. The API (950) may be either computer-language independent or dependent and refer to a complete interface, a single function, or even a set of APIs. The service layer (960) provides software services to the computer (900) or other components (whether or not illustrated) that are communicably coupled to the computer (900). The functionality of the computer (900) may be accessible for all service consumers using this service layer. Software services, such as those provided by the service layer (960), provide reusable, defined business functionalities through a defined interface. For example, the interface may be software written in JAVA, C++, or other suitable language providing data in extensible markup language (XML) format or other suitable format. While illustrated as an integrated component of the computer (900), alternative implementations may illustrate the API (950) or the service layer (960) as stand-alone components in relation to other components of the computer (900) or other components (whether or not illustrated) that are communicably coupled to the computer (900). Moreover, any or all parts of the API (950) or the service layer (960) may be implemented as child or sub-modules of another software module, enterprise application, or hardware module without departing from the scope of this disclosure.

The computer (900) includes an interface (920). Although illustrated as a single interface (920) in FIG. 9, two or more interfaces (920) may be used according to particular needs, desires, or particular implementations of the computer (900). The interface (920) is used by the computer (900) for communicating with other systems in a distributed environment that are connected to the network (910). Generally, the interface (920 includes logic encoded in software or hardware (or a combination of software and hardware) and operable to communicate with the network (910). More specifically, the interface (920) may include software supporting one or more communication protocols associated with communications such that the network (910) or interface's hardware is operable to communicate physical signals within and outside of the illustrated computer (900).

The computer (900) includes at least one computer processor (930). Although illustrated as a single computer processor (930) in FIG. 9, two or more processors may be used according to particular needs, desires, or particular implementations of the computer (900). Generally, the computer processor (930) executes instructions and manipulates data to perform the operations of the computer (900) and any algorithms, methods, functions, processes, flows, and procedures as described in the instant disclosure.

The computer (900) also includes a memory (980) that holds data for the computer (900) or other components (or a combination of both) that can be connected to the network (910). For example, memory (980) can be a database storing data consistent with this disclosure. Although illustrated as a single memory (980) in FIG. 9, two or more memories may be used according to particular needs, desires, or particular implementations of the computer (900) and the described functionality. While memory (980) is illustrated as an integral component of the computer (900), in alternative implementations, memory (980) can be external to the computer (900).

The application (940) is an algorithmic software engine providing functionality according to particular needs, desires, or particular implementations of the computer (900), particularly with respect to functionality described in this disclosure. For example, application (940) can serve as one or more components, modules, applications, etc. Further, although illustrated as a single application (940), the application (940) may be implemented as multiple applications (940) on the computer (900). In addition, although illustrated as integral to the computer (900), in alternative implementations, the application (940) can be external to the computer (900).

There may be any number of computers (900) associated with, or external to, a computer system containing computer (900), each computer (900) communicating over network (910). Further, the term “client,” “user,” and other appropriate terminology may be used interchangeably as appropriate without departing from the scope of this disclosure. Moreover, this disclosure contemplates that many users may use one computer (900), or that one user may use multiple computers (900).

In some embodiments, the computer (900) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for deep learning-based perception, the method comprising:
obtaining input data using a plurality of cameras and a plurality of sensors, the input data including a plurality of images and a plurality of sensor data;
training, using a computer processor and a machine learning algorithm, a trunk-head machine learning model;
generating, using the computer processor, an intermediate representation data using the trunk-head machine learning model and based on the obtained input data;
determining, using the computer processor, a plurality of information recognized in the intermediate representation data using the trunk-head machine learning model; and
adjusting, using the computer processor, a configuration of a forklift based on the determined plurality of information.

2. The method of claim 1, wherein the trunk-head machine learning model includes a convolutional neural network (CNN) model.

3. The method of claim 1, wherein the trunk-head machine learning model includes a You Look Only Once (YOLO) model.

4. The method of claim 1, wherein the intermediate representation data includes a plurality of recognized patterns and objects from the input data.

5. The method of claim 1, wherein the trunk-head machine learning model includes a plurality of heads, each head of the plurality of heads specializing in determining a single object.

6. The method of claim 5, wherein each of the plurality of heads may determine an information about a plurality of characteristics of the object.

7. The method of claim 6, wherein the plurality of heads includes a pallet detection head, a pallet pocket detection head, a person detection head, a forklift detection head, and a load restraint detection head.

8. The method of claim 7, wherein a plurality of load restraints is detected using the load restraint detection head, and
wherein the load restraint detection head detects that the plurality of load restraints are removed before executing an unloading process.

9. A non-transitory computer readable medium storing instructions executable by a computer processor, the instructions comprising functionality for:
obtaining input data using a plurality of cameras and a plurality of sensors, the input data including a plurality of images and a plurality of sensor data;
training, using a machine learning algorithm, a trunk-head convolutional neural network (CNN) machine learning model;
generating an intermediate representation data using the trunk-head CNN machine learning model and based on the obtained input data;
determining a plurality of information from an object recognized in the intermediate representation data using the trunk-head CNN machine learning model; and
adjusting a configuration of a forklift based on the determined plurality of information.

10. The non-transitory computer readable medium of claim 9, wherein the trunk-head machine learning model includes a convolutional neural network (CNN) model.

11. The non-transitory computer readable medium of claim 9, wherein the trunk-head machine learning model includes a You Look Only Once (YOLO) model.

12. The non-transitory computer readable medium of claim 9, wherein the intermediate representation data includes a plurality of recognized patterns and objects from the input data.

13. The non-transitory computer readable medium of claim 9, wherein the trunk-head machine learning model includes a plurality of heads, each head of the plurality of heads specializing in determining a single object.

14. The non-transitory computer readable medium of claim 13, wherein each head of the plurality of heads may determine a plurality of information about a plurality of characteristic of the object.

15. The non-transitory computer readable medium of claim 14, wherein the plurality of heads includes a pallet detection head, a pallet pocket detection head, a person detection head, a forklift detection head, and a load restraint detection head.

16. The non-transitory computer readable medium of claim 15, wherein a plurality of load restraints is detected using the load restraint detection head, and
wherein the load restraint detection head detects that the plurality of load restraints are removed before executing an unloading process.

17. A system comprising:
a plurality of cameras;
a plurality of sensors; and
a computer processor, wherein the computer processor is coupled to the plurality of cameras and the plurality of sensors, the computer processor comprising functionality for:
obtaining input data using the plurality of cameras and the plurality of sensors, the input data including a plurality of images and a plurality of sensor data;
training, using a machine learning algorithm, a trunk-head convolutional neural network (CNN) machine learning model;
generating an intermediate representation data using the trunk-head CNN machine learning model and based on the obtained input data;
determining a plurality of information from an object recognized in the intermediate representation data using the trunk-head CNN machine learning model; and
adjusting a configuration of a forklift based on the determined plurality of information.

18. The system of claim 17, wherein the trunk-head machine learning model includes a plurality of heads, each head of the plurality of heads specializing in determining a single object.

19. The system of claim 18, wherein each head of the plurality of heads may determine a plurality of information about a plurality of characteristic of the object.

20. The system of claim 19, wherein the plurality of heads includes a pallet detection head, a pallet pocket detection head, a person detection head, a forklift detection head, and a load restraint detection head.
